(19) United States
(12) Patent Application Publication
(10) Pub. No.: US 2024/0161409 A1
(43) Pub. Date: May 16, 2024

(54) ANNOTATION APPARATUS, ANNOTATION METHOD, AND NON-TRANSITORY COMPUTER READABLE MEDIUM

(71) Applicant: NEC Corportion, Minato-ku, Tokyo (JP)

(72) Inventors: Jiro ABE, Tokyo (JP); Akira TSUJI, Tokyo (JP)

(73) Assignee: NEC Corportion, Minato-ku, Tokyo (JP)

(21) Appl. No.: 18/282,923

(22) PCT Filed: Mar. 24, 2021
(86) PCT No.: PCT/JP2021/012337

§ 371 Date: Sep. 19, 2023

(51) Int. Cl. G06T 19/00

(52) U.S. Cl. CPC G06T 19/00; G06T 2210/56; G06T 2219/004

(57) ABSTRACT

An object of the present disclosure is to provide an annotation apparatus that can improve workability of annotation. An annotation apparatus (1) according to an example aspect of the present disclosure includes a cluster generation unit (11) configured to generate a plurality of clusters by grouping point cloud data corresponding to three-dimensional position information about a measurement target, a presentation order determination unit (12) configured to determine a presentation order of the plurality of clusters based on similarity between the generated plurality of clusters, a cluster presentation unit (13) configured to present the plurality of clusters in order based on the determined presentation order, and a label assignment unit (14) configured to assign a predetermined label to each of the clusters presented in the order.

### TECHNICAL FIELD

The present disclosure relates to an annotation apparatus, an annotation method, and a non-transitory computer readable medium.

### BACKGROUND ART

In recent years, a technique has been developed to acquire point cloud data, which is three-dimensional position information about a measurement target, using three-dimensional distance sensors such as LIDAR (Light Detection And Ranging). For example, a technique has been developed to use such point cloud data of a measurement target to automatically identify equipment, parts, etc., and manage facilities or the like. In such techniques, it is necessary to assign a predetermined label to the point cloud data and create teacher data in advance in order to automatically identify equipment, components, etc.

Patent Literature 1 discloses a technique for an object recognition apparatus that can recognize objects with high accuracy using point cloud data provided by LIDAR. Patent Literature 2 also discloses a technique of a method for annotating point cloud data.

### CITATION LIST

### Patent Literature

Patent Literature 1: Japanese Unexamined Patent Application Publication No. 2019-185347

Patent Literature 2: Japanese Unexamined Patent Application Publication No. 2018-63236

### SUMMARY OF INVENTION

### Technical Problem

As described above, in order to automatically identify a predetermined object using the point cloud data of a measurement target, it is necessary to assign a predetermined label to the point cloud data and create teacher data in advance. An annotation work of assigning a predetermined label to the point cloud data is performed, for example, by a user assigning a predetermined label to each point of the point cloud data. Specifically, the points close in distance to each other are grouped together to generate a cluster, and all the generated clusters are displayed on a display unit. The user then, while checking the clusters displayed on the display unit on a screen, assigns a label to each cluster.

However, if, while the user is checking all the clusters displayed on the display unit on the screen, he/she performs the annotation work, there is a problem that the annotation work becomes complicated, because an amount of the point cloud data of a measurement target is enormous.

An object of the present disclosure is to provide an annotation apparatus, an annotation method, and a non-transitory computer readable medium that can improve workability of annotation.

### Solution to Problem

An annotation apparatus according to an example aspect of the present disclosure includes: a cluster generation unit configured to generate a plurality of clusters by grouping point cloud data corresponding to three-dimensional position information about a measurement target; a presentation order determination unit configured to determine a presentation order of the plurality of clusters based on similarity between the generated plurality of clusters; a cluster presentation unit configured to present the plurality of clusters in order based on the determined presentation order; and a label assignment unit configured to assign a predetermined label to each of the clusters presented in the order.

An annotation method according to an example aspect of the present disclosure includes: generating a plurality of clusters by grouping point cloud data corresponding to three-dimensional position information about a measurement target; determining a presentation order of the plurality of clusters based on similarity between the generated plurality of clusters; presenting the plurality of clusters in order based on the determined presentation order; and assigning a predetermined label to each of the clusters presented in the order.

A non-transitory computer readable medium according to an example aspect of the present disclosure stores a program for causing a computer to execute annotation processing including: processing of generating a plurality of clusters by grouping point cloud data corresponding to three-dimensional position information about a measurement target; processing of determining a presentation order of the plurality of clusters based on similarity between the generated plurality of clusters; processing of presenting the plurality of clusters in order based on the determined presentation order; and processing of assigning a predetermined label to each of the clusters presented in the order.

### Advantageous Effects of Invention

According to the present disclosure, it is possible to provide an annotation apparatus, an annotation method, and a non-transitory computer readable medium that can improve workability of annotation.

### BRIEF DESCRIPTION OF DRAWINGS

FIG. 1 is a block diagram showing a configuration example of an annotation apparatus according to an example embodiment;

FIG. 2 is a flowchart for explaining an example operation of the annotation apparatus according to the example embodiment;

FIG. 3 is a diagram for explaining an example operation of generating a plurality of clusters;

FIG. 4A is a diagram for explaining an example operation of determining an order in which clusters are presented;

FIG. 4B is a diagram for explaining an example operation of determining the order in which the clusters are presented;

FIG. 4C is a diagram for explaining an example operation of determining the order in which the clusters are presented;

FIG. 4D is a diagram for explaining an example operation of determining the order in which the clusters are presented;

FIG. 5 is a diagram for explaining an example operation of determining the order in which the clusters are presented;

FIG. 6 shows an example of point cloud data of a measurement target;

FIG. 7A shows an example of annotation processing;

FIG. 7B shows an example of the annotation processing;

FIG. 7C shows an example of the annotation processing;

FIG. 7D shows an example of the annotation processing; and

FIG. 8 is a block diagram showing an example of a hardware configuration including an annotation apparatus according to the example embodiment.

### EXAMPLE EMBODIMENT

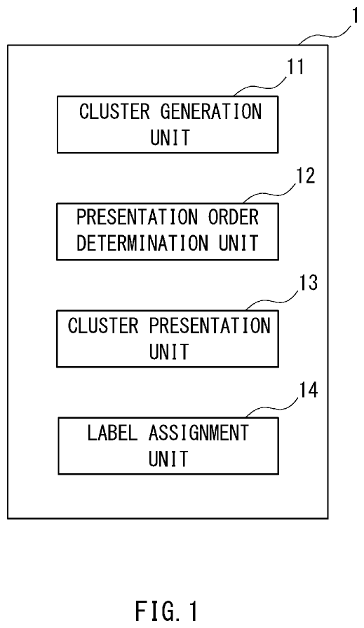

An example embodiment of the present disclosure will be described below with reference to the drawings. FIG. 1 is a block diagram showing a configuration example of an annotation apparatus according to an example embodiment. As shown in FIG. 1, an annotation apparatus 1 according to this example embodiment includes a cluster generation unit 11, a presentation order determination unit 12, a cluster presentation unit 13, and a label assignment unit 14.

The annotation apparatus 1 according to this example embodiment performs annotation processing to assign a predetermined label to point cloud data corresponding to three-dimensional position information about a measurement target. The three-dimensional position information about the measurement target can be acquired in advance using a three-dimensional distance sensor such as LIDAR.

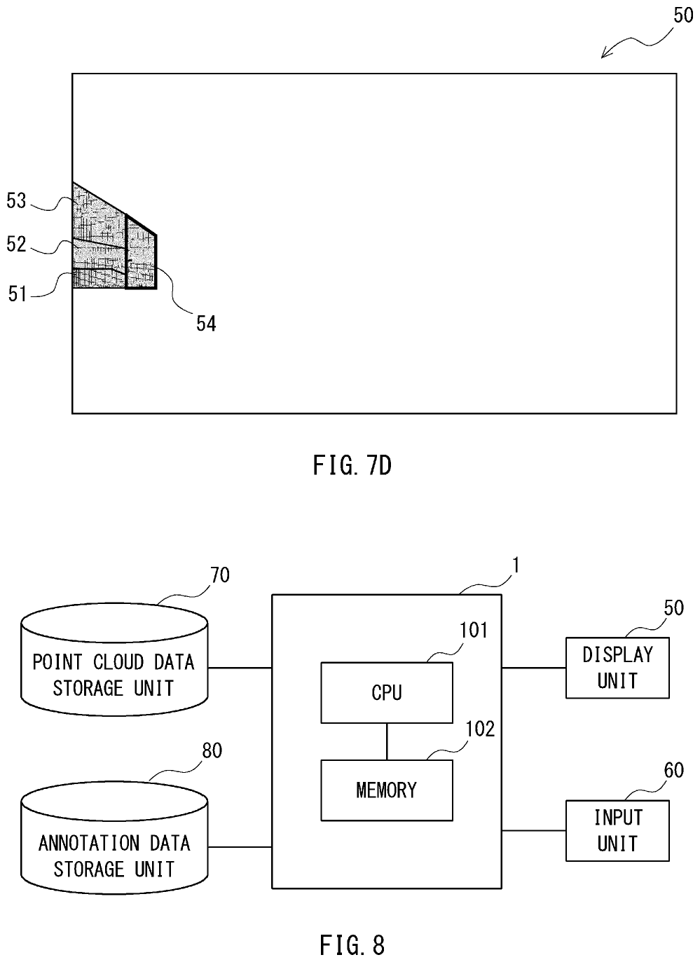

The cluster generation unit 11 generates a plurality of clusters by grouping point cloud data corresponding to the three-dimensional position information about the measurement target. That is, the cluster generation unit 11 generates the plurality of clusters by grouping the points included in the point cloud data. For example, the point cloud data corresponding to the three-dimensional position information about the measurement target is stored in the point cloud data storage unit 70 (see FIG. 8). The point cloud data stored in the point cloud data storage unit is supplied to the cluster generation unit 11.

For example, the cluster generation unit 11 generates a cluster so that points corresponding to the same structure are included in the same cluster. In other words, the cluster generation unit 11 generates a cluster so that different structures are not included in the same cluster. In this example embodiment, the same structure may be finely divided into clusters. In this case, the clusters are generated so that a plurality of clusters are included in the same structure.

Specifically, the cluster generation unit 11 can generate a plurality of clusters using graph cut segmentation, region expansion method, super voxel division, or the like. Graph cut segmentation is a method of generating a graph based on a neighborhood relationship between the points in the point cloud data and performing graph cut based on a value of a shape feature quantity. For example, the shape feature quantity can be obtained using Principal Component Analysis (PCA). Region Growing is a method of generating clusters by repeating random selection of seed points and extension to neighborhood points with similar information. Supervoxel Segmentation is a method of generating clusters by dividing an entire space into fine cubic lattices (voxels) and fine-tuning the shape of each voxel along the contours and object boundaries. Note that the method of generating clusters in this example embodiment is not limited to these, and other existing methods may be used to generate clusters.

The presentation order determination unit 12 determines a presentation order of the plurality of clusters based on the similarity between the plurality of clusters generated by the cluster generation unit 11. Specifically, the presentation order determination unit 12 determines the presentation order of the plurality of clusters based on at least one of spatial similarity and visual similarity of the plurality of clusters. In other words, the presentation order determination unit 12 determines the presentation order of the plurality of clusters so that clusters that are similar in appearance and space are brought together in order. At this time, the presentation order determination unit 12 may determine that the closer the spatial positional relationship between the plurality of clusters, the higher the spatial similarity. Further, the presentation order determination unit 12 may determine that the closer the appearance of the plurality of the clusters, the higher the visual similarity. Here, the visual similarity is the degree of similarity in shape, the degree of similarity in color (RGB information), the degree of similarity in reflection intensity, or the like. For example, the presentation order determination unit 12 may determine that the more similar the shapes of the plurality of clusters are, the higher the visual similarity is. The presentation order determination unit 12 may also determine that the more similar the colors (RGB information) of the plurality of clusters are, the higher the visual similarity is. The presentation order determination unit 12 may also determine that the more similar the reflection intensities of the plurality of clusters are, the higher the visual similarity is. Details of how the presentation order determination unit 12 determines the presentation order of the plurality of clusters will be described later.

The cluster presentation unit 13 presents the plurality of clusters in order based on the presentation order determined by the presentation order determination unit 12. For example, the cluster presentation unit 13 presents the plurality of clusters in order to a user by displaying the clusters in order on a separately provided display unit 50 (see FIG. 8).

The label assignment unit 14 assigns a predetermined label to each cluster sequentially presented by the cluster presentation unit 13. Specifically, the label assignment unit 14 assigns a label to each cluster according to a predetermined input. For example, the label assignment unit 14 assigns a label to each cluster according to a result of an input by a separately provided input unit 60 (see FIG. 8).

For example, the cluster presentation unit 13 sequentially presents each of the plurality of clusters in turn based on the presentation order determined by the presentation order determination unit 12. The label assignment unit 14 assigns a label to each cluster presented sequentially according to a predetermined input.

The annotation apparatus 1 according to this example embodiment can perform annotation processing on the point cloud data by repeating the processing in which the cluster presentation unit 13 sequentially presents each of the plurality of clusters in turn, and the processing in which the label assignment unit 14 assigns a label to each cluster according to a predetermined input.

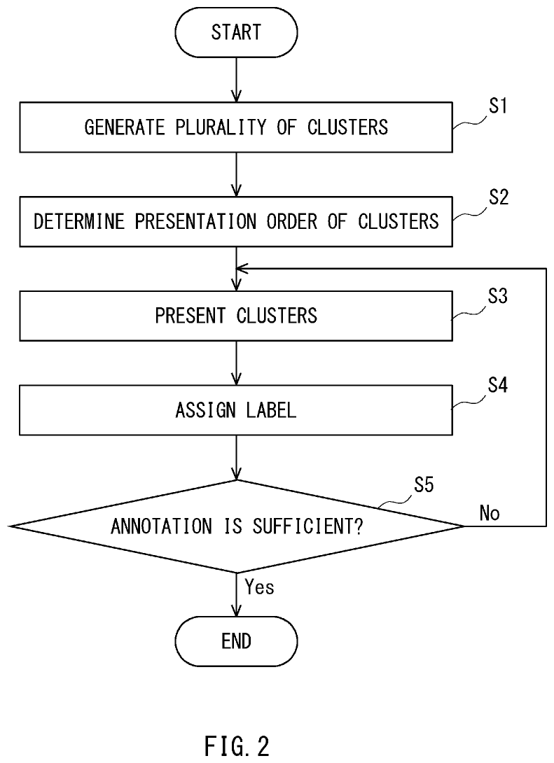

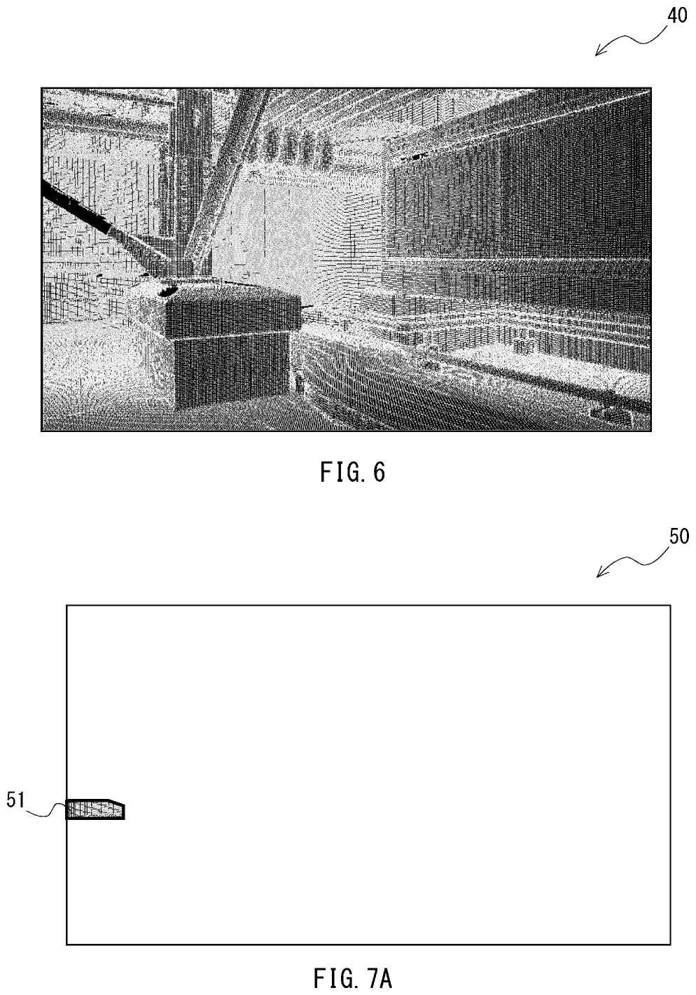

Next, an operation of the annotation apparatus (annotation method) according to this example embodiment will be described. FIG. 2 is a flowchart for explaining the operation of the annotation apparatus according to this example embodiment. In this example embodiment, before the annotation processing is performed using the annotation apparatus 1, the point cloud data corresponding to the three-dimensional position information about the measurement target is acquired in advance using a three-dimensional distance sensor such as LIDAR. FIG. 6 shows an example of point cloud data 40. As shown in FIG. 6, the point cloud data 40 corresponds to three-dimensional position information about the measurement target and includes information such as a distance from a position information acquisition apparatus such as LiDAR to the measurement target, intensity of reflection, and three-dimensional coordinates. The point cloud data is stored, for example, in a point cloud data storage unit 70 (see FIG. 8).

As shown in FIG. 2, when the annotation processing is performed, the cluster generation unit 11 first generates a plurality of clusters by grouping the point cloud data corresponding to the three-dimensional position information about the measurement target (Step S1). For example, the cluster generation unit 11 generates clusters so that points corresponding to the same structure are included in the same cluster.

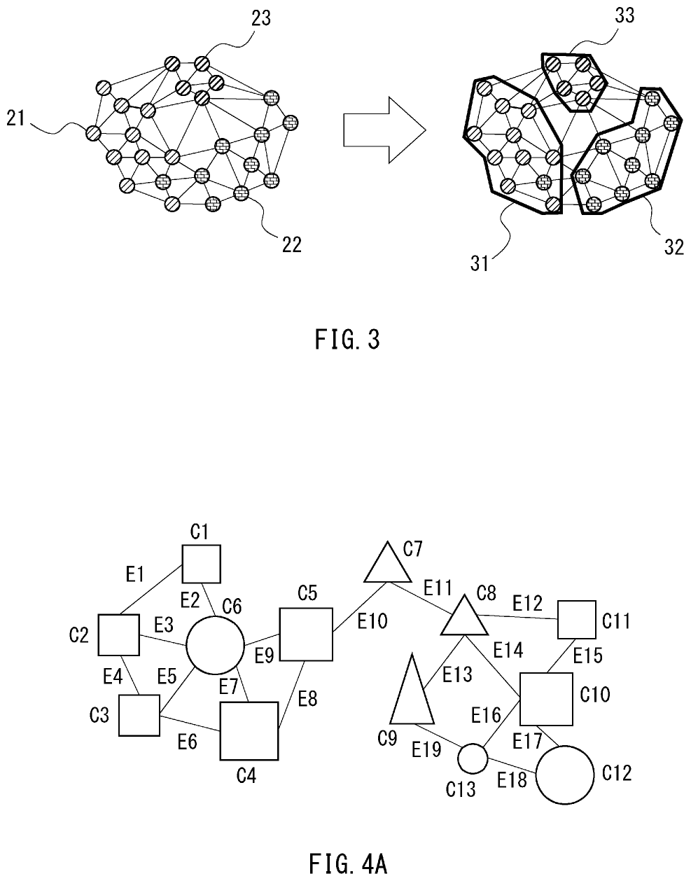

FIG. 3 is a diagram for explaining an example of an operation of generating a plurality of clusters, and a diagram for explaining an example of graph cut segmentation. First, as shown in the left drawing of FIG. 3, a graph is created based on the neighborhood relationship between the points on the point cloud data. In FIG. 3, the difference between shape feature quantities of the points including points 21, 22, and 23 of the point cloud data is expressed by the variations in the hatching patterns. As shown in the right drawing of FIG. 3, a plurality of clusters 31, 32, and 33 are generated by cutting edges of the graph so that the points with similar shape feature quantities are grouped together (graph cut).

In the example shown in FIG. 3, a plurality of adjacent points with similar shape feature quantities to that of the point 21 constitute the cluster 31. In addition, a plurality of adjacent points with similar shape feature quantities to that of the point 22 constitute the cluster 32. Further, a plurality of adjacent points with similar shape feature quantities to that of the point 23 constitute the cluster 33. The cluster generation method shown in FIG. 3 is an example, and in this example embodiment, a plurality of clusters may be generated using a method other than that shown in FIG. 3.

Next, the presentation order determination unit 12 shown in FIG. 1 determines the presentation order of the plurality of clusters based on the similarity between the plurality of clusters generated by the cluster generation unit 11 (Step S2 in FIG. 2). Specifically, the presentation order determination unit 12 determines the presentation order of the plurality of clusters based on at least one of the spatial similarity and the visual similarity between the plurality of clusters. In other words, the presentation order determination unit 12 determines the presentation order of the plurality of clusters so that the clusters that are similar in appearance and space are brought together in order.

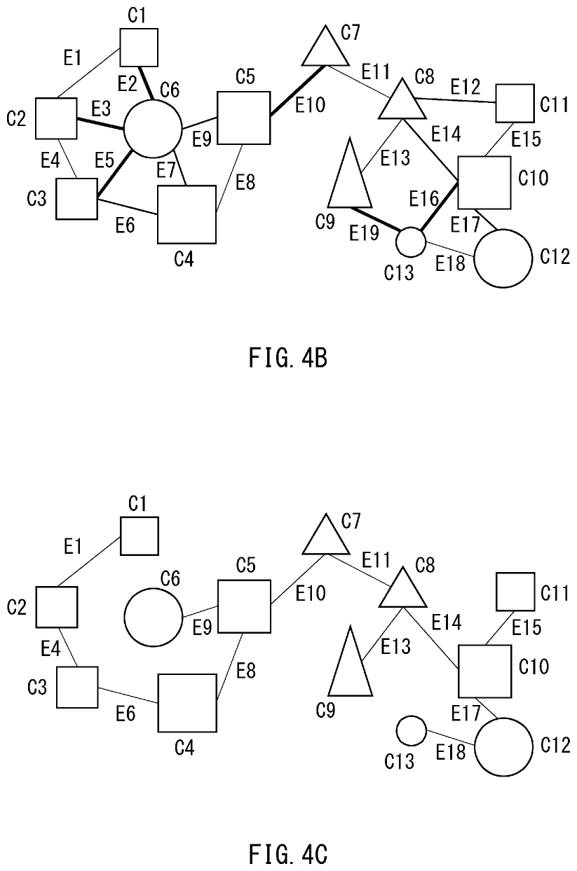

FIGS. 4A to 4D are diagrams for explaining an example of the operation of determining the presentation order of the clusters. In FIGS. 4A to 4D, signs C1 to C13 denote a plurality of clusters. For the sake of simplicity, the plurality of clusters C1 to C13 are shown as circles, triangles, and squares in FIGS. 4A to 4D.

First, as shown in FIG. 4A, the presentation order determination unit 12 creates a graph by coupling the plurality of clusters C1 to C13 to each other with edges E1 to E19 based on the spatial similarity between the plurality of clusters C1 to C13. For example, the presentation order determination unit 12 may couple clusters that are spatially in neighborhood relation to each other with edges. In this case, the presentation order determination unit 12 may use K-nearest neighbor search to couple clusters that are in neighborhood relation to each other with edges. Moreover, a threshold may be set for a distance between centroids of the respective clusters, and clusters whose thresholds are equal to or less than a predetermined value may be coupled to each other with edges. Alternatively, a threshold may be set for the shortest distance between the clusters, and clusters whose thresholds are equal to or less than a predetermined value may be coupled to each other with edges.

Next, as shown in FIG. 4B, the presentation order determination unit 12 sets a weight for each of the edges E1 to E19 coupling the clusters based on the visual similarity between the plurality of clusters C1 to C13. Specifically, the presentation order determination unit 12 sets the weights of the edges coupling the clusters that are similar in appearance to each other to be small. As shown in FIG. 4, the clusters C1 to C3 are square and the cluster C6 is circular. Since they have different shapes, the weights of the edges E2, E3, and E5 coupling the clusters C1 to C3 to the cluster C6 are set to “large” (in FIG. 4B, the larger the weight, the thicker the line. In other words, the thicker the line, the greater the difference between the shapes of the clusters). It should be noted that the clusters C4 and C5 are square and the cluster C6 is circular, and since they have different shapes but similar sizes, the weights of the edges E7 and E9 are set to “medium”.

In addition, since the clusters C1 to C3 are square and similar in shape and size to each other, the weights of the edges E1 and E4 coupling the clusters C1 to C3 are set to “small”. In addition, since the clusters C3 and C4 are square and the shapes thereof are similar to each other but the sizes thereof are different from each other, the weight of the edge E6 coupling the clusters C3 and C4 is set to “medium”. Further, since the clusters C4 and C5 are square and the shapes and sizes thereof are similar to each other, the weights of the edge E8 coupling the clusters C4 and C5 are set to “small”. The weights of the edges E10 to E19 coupling the clusters C7 to C13 can also be set using a method similar to the above method. The weight setting of each of the edges E1 to E19 coupling each of the clusters C1 to C13 can be made, for example, by performing error calculations based on Principal Component Analysis (PCA) feature quantities or normal distributions.

Next, the presentation order determination unit 12 determines the presentation order of each of the clusters C1 to C13 based on the set weight of each of the edges E1 to E19.

Specifically, first, as shown in FIG. 4C, the presentation order determination unit 12 creates a minimum spanning tree of the plurality of the clusters C1 to C13 based on the set weights of the respective edges E1 to E19. In the example shown in FIG. 4C, the minimum spanning tree is created by preferentially leaving edges with smaller weights. It should be noted that the edge E10 has a weight set to “large”, but the edge E10 is left, because it is necessary for coupling the cluster C5 to the cluster C7.

After that, as shown in FIG. 4D, the presentation order determination unit 12 performs a depth-first search on the minimum spanning tree to determine the presentation order of each of the clusters C1 to C13. In the example shown in FIG. 4D, the presentation order of the cluster C1 is first, and after that, the presentation order is set as the clusters C2, C3, . . . , and C13.

At this time, the presentation order determination unit 12 may perform a depth-first search on the minimum spanning tree, prioritizing reduction in spatial gaps between the clusters C1 to C13. That is, by selecting a priority of a branch or a root node so that the spatial gaps between the presented cluster become small, the clusters can be presented to the user in an appropriate order.

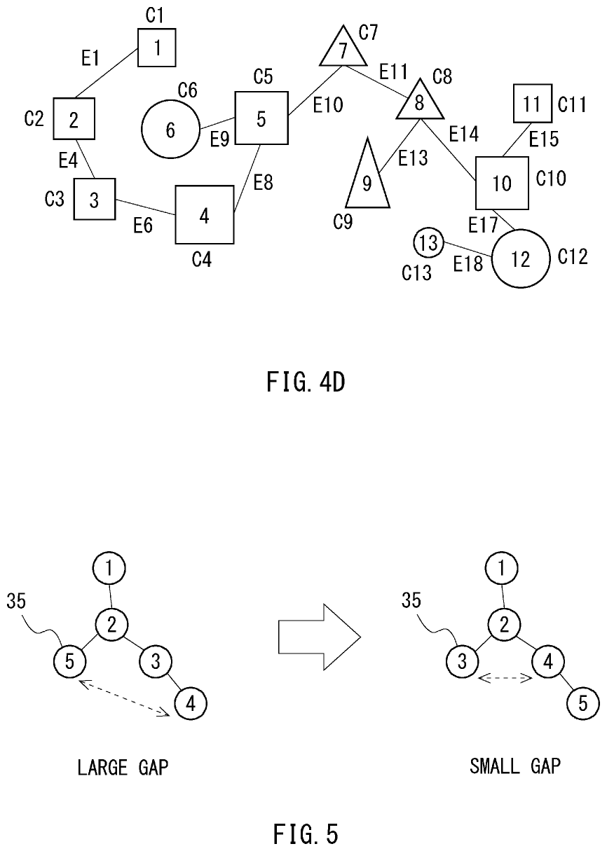

Specifically, with reference to FIG. 5, the spatial gap between the fourth and fifth clusters increases, because the cluster 35 is ranked fifth in the left drawing of FIG. 5. In contrast, since the cluster 35 is ranked third in the right drawing of FIG. 5, the spatial gap between the third cluster 35 and the fourth cluster can be reduced, and thus the spatial gap of the entire minimum spanning tree can be reduced.

Next, the cluster presentation unit 13 shown in FIG. 1 presents the plurality of clusters C1 to C13 in order based on the presentation order determined by the presentation order determination unit 12 (Step S3 in FIG. 2). For example, the cluster presentation unit 13 presents the plurality of clusters C1 to C13 in order to the user by displaying each of the clusters C1 to C13 in order on the separately provided display unit 50 (see FIG. 8).

The label assignment unit 14 assigns a predetermined label to each of the clusters C1 to C13 sequentially presented by the cluster presentation unit 13 (Step S4). Specifically, the label assignment unit 14 assigns a label to each of the clusters C1 to C13 according to a predetermined input. For example, the label assignment unit 14 assigns a label to each of the clusters C1 to C13 according to a result of an input through the separately provided input unit 60 (see FIG. 8).

Next, when the assignment of the labels to the clusters C1 to C13 is not completed, that is, when the annotation is not sufficient (Step S5: No), the operation of Steps S3 to S5 is repeated. That is, in this example embodiment, the annotation processing can be performed on the point cloud data by repeating the processing in which the cluster presentation unit 13 sequentially presents each of the plurality of clusters C1 to C13 in turn, and the processing in which the label assignment unit 14 assigns a label to each of the clusters C1 to C13 according to a predetermined input.

To be more specific, the cluster presentation unit 13 first displays the cluster C1 on the display unit and presents the cluster C1 to the user. Next, the user inputs the label of the cluster C1 using the input unit. The label assignment unit 14 assigns the label to the cluster C1 according to the input of the user. Next, the cluster presentation unit 13 displays the cluster C2 on the display unit and presents the cluster C2 to the user. Next, the user inputs the label of the cluster C2 using the input unit. The label assignment unit 14 assigns the label to the cluster C2 according to the input of the user. Next, the cluster presentation unit 13 displays the cluster C3 on the display unit and presents the cluster C3 to the user. Next, the user inputs the label of the cluster C3 using the input unit. The label assignment unit 14 assigns the label to the cluster C3 according to the input of the user. After that, the annotation processing can be performed by performing the same processing on the clusters C4 to C13. When the assignment of the labels to the clusters C1 to C13 is completed, that is, when it is determined that the annotation is sufficient (Step S5: Yes), the annotation processing is ended.

In the flowchart shown in FIG. 2, an example in which the presentation order determination unit 12 determines the presentation order for all the clusters and then the cluster presentation unit 13 presents the plurality of clusters to the user in order has been described. However, in this example embodiment, the presentation order determination unit 12 may sequentially determine the presentation order of the plurality of clusters. In this case, for each cluster, the presentation order determination unit 12 performs processing of determining the cluster to be presented next, the cluster presentation unit 13 presents the cluster, and the label assignment unit 14 assigns a label to the cluster. That is, in the flowchart of FIG. 2, after No in Step S5, the processing may be returned to Step S2.

In the above description, the case where the presentation order determination unit 12 determines the presentation order of the clusters in the steps shown in FIGS. 4A to 4D has been described. However, in this example embodiment, it is not necessary to perform all the steps shown in FIGS. 4A to 4D, if similar clusters are presented in a similar order. For example, as shown in FIG. 4A, the presentation order determination unit 12 couples each of the plurality of clusters C1 to C13 with the edges E1 to E19 based on the spatial similarity between the plurality of clusters C1 to C13. Next, the order of the clusters C1 to C13 to be presented may be determined by tracing the edges E1 to E19 in a specified sequence. Again, spatially similar clusters are presented in order.

Furthermore, in this example embodiment, it is not necessary for the user to input the label of the cluster every time in the processing of assigning a label in Step S4 of FIG. 2. For example, if the cluster presented this time is sufficiently similar to the cluster presented last time, the label assignment unit 14 may automatically assign the same label to the cluster presented this time as the cluster presented last time.

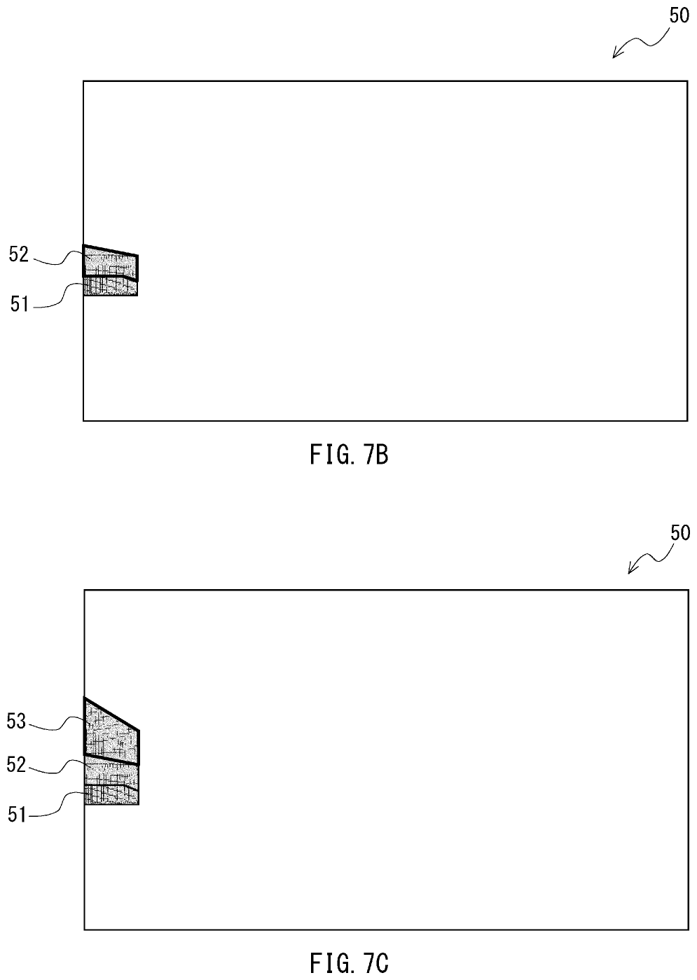

Next, the processing of Steps S3 to S5 will be described in detail with reference to FIGS. 7A to 7D. FIGS. 7A to 7D are diagrams for explaining one example of the annotation processing and the case in which the annotation processing is performed on the point cloud data shown in FIG. 6. It is assumed that the processing of Steps S1 to S2 has been performed on the point cloud data shown in FIG. 6 in advance. That is, it is assumed that a plurality of clusters are generated by grouping the point cloud data shown in FIG. 6, and the order in which the plurality of clusters are presented is determined based on the similarity between the generated plurality of clusters.

First, as shown in FIG. 7A, the cluster presentation unit 13 displays the first cluster 51 to be presented, which has been determined by the presentation order determination unit 12, on the display unit 50. The user inputs a label of the cluster 51 displayed on the display unit 50. Since the cluster 51 is classified as being a “wall”, the user inputs the label indicating the “wall”. The label assignment unit 14 assigns the label indicating the “wall” to the cluster C1.

Next, as shown in FIG. 7B, the cluster presentation unit 13 displays the cluster 52 to be presented second, which has been determined by the presentation order determination unit 12, on the display unit 50. The cluster 52 is spatially and visually similar to the cluster 51. The user inputs a label of the cluster 52 displayed on the display unit 50. Since the cluster 52 is classified as being a “wall”, the user inputs the label indicating the “wall”. The label assignment unit 14 assigns the label indicating the “wall” to the cluster C52.

Next, as shown in FIG. 7C, the cluster presentation unit 13 displays the cluster 53 to be presented third, which has been determined by the presentation order determination unit 12, on the display unit 50. The cluster 53 is spatially and visually similar to the cluster 52. The user inputs a label of the cluster 53 displayed on the display unit 50. Since the cluster 53 is classified as being a “wall”, the user inputs the label indicating the “wall”. The label assignment unit 14 assigns the label indicating the “wall” to the cluster C53.

Next, as shown in FIG. 7D, the cluster presentation unit 13 displays the cluster 54 to be presented fourth, which has been determined by the presentation order determination unit 12, on the display unit 50. The cluster 54 is spatially and visually similar to the clusters 51 to 53. The user inputs a label of the cluster 54 displayed on the display unit 50. Since the cluster 54 is classified as being a “wall”, the user inputs the label indicating the “wall”. The label assignment unit 14 assigns the label indicating the “wall” to the cluster 54. After that, by repeating the same operation, the annotation processing can be performed on the point cloud data.

Since the clusters 51 to 54 are similar to each other in the above example, the label assignment unit 14 may automatically assign the same label (“wall”) to the cluster presented this time as that of the cluster presented last time. In this case, the user's input of the label can be omitted.

In the annotation processing shown in FIGS. 7A to 7D, an example in which the clusters 51 to 54 are presented to the user in order is shown. Alternatively, in this example embodiment, the cluster presentation unit 13 may collectively present clusters similar to each other. For example, when the cluster presentation unit 13 presents the cluster 51, it may collectively present the clusters 52 to 54 that are spatially and visually similar to the cluster 51.

In addition, while the case in which the clusters 51 to 54 are sequentially added to the display unit 50 has been described as an example in FIGS. 7A to 7D, the method of displaying the clusters according to this example embodiment is not limited to the case in which clusters are sequentially added. For example, when the cluster 52 is displayed on the display unit 50 in FIG. 7B, the cluster 51 may be hidden.

In addition, while the case in which the clusters 51 to 54 are displayed sequentially on the empty display unit 50 has been described as an example in FIGS. 7A to 7D, the cluster may be highlighted and displayed in this example embodiment. That is, while the original point cloud data 40 (see FIG. 6) is displayed in the background, the clusters 51 to 54 to which the labels are assigned may be highlighted in red or a thick frame on the background point cloud data 40.

As described in the background technique, in order to automatically identify a predetermined object using the point cloud data of a measurement target, it is necessary to assign a predetermined label to the point cloud data and create teacher data in advance. The annotation work of assigning a predetermined label to the point cloud data is performed, for example, by the user assigning a predetermined label to each point of the point cloud data. However, when the annotation work is performed while the user checks all the clusters displayed on the display unit on the screen, there is a problem that the annotation work becomes complicated, because the point cloud data of a measurement target is enormous (i.e., because the point cloud data includes so many points).

For example, when a plurality of clusters are generated by grouping the point cloud data, and then these plurality of clusters are displayed together on the display unit, the work of assigning labels by the user becomes complicated. Especially, when the number of clusters increases, visibility of an operation screen decreases significantly. Moreover, when the annotation processing is performed by the user specifying a partial range of the point cloud data with a mouse, the work becomes complicated, because the user needs to perform operations such as range specification for each piece of the enormous point cloud data.

In contrast, in this example embodiment, a plurality of clusters are generated by grouping the point cloud data, the presentation order of the plurality of clusters is determined based on the similarity between the plurality of clusters, and the plurality of clusters are presented to the user in order based on the determined presentation order. Therefore, the number of clusters displayed on the display unit can be reduced, so that the visibility can be improved. In addition, a plurality of clusters are automatically generated by grouping the point cloud data, so that the user does not need to perform operations such as range specification. Therefore, the operability can be improved.

Therefore, according to the present disclosure, it is possible to provide an annotation apparatus, an annotation method, and a non-transitory computer readable medium that can improve workability of annotation.

This example embodiment can be also implemented by causing a CPU (Central Processing Unit) to execute a computer program to perform processing of each component.

That is, this example embodiment can be implemented by causing a computer to execute: processing of generating a plurality of clusters by grouping point cloud data corresponding to three-dimensional position information about a measurement target; processing of determining a presentation order of the plurality of clusters based on similarity between the generated plurality of clusters; processing of presenting the plurality of clusters in order based on the determined presentation order; and processing of assigning a predetermined label to each of the clusters presented in the order.

FIG. 8 is a block diagram for explaining an example of a hardware configuration including the annotation apparatus according to this example embodiment. As shown in FIG. 8, the annotation apparatus 1 according to this example embodiment can be configured using a CPU (101) and a memory 102. That is, the annotation apparatus 1 can be configured by causing the CPU (101) to execute the program of the annotation processing described above. The display unit 50, the input unit 60, the point cloud data storage unit 70, and an annotation data storage unit 80 are connected to the annotation apparatus 1.

The display unit 50 is configured using a liquid crystal display, an organic EL (electro-luminescence) display, or the like. The plurality of clusters output from the cluster presentation unit 13 (see FIG. 1) are displayed on the display unit 50. At this time, a plurality of clusters are sequentially displayed on the display unit 50 based on the presentation order determined by the presentation order determination unit 12. Thus, the user can view each cluster in a predetermined order.

The input unit 60 is a user-operated device for inputting label information for a plurality of clusters and can be configured using a keyboard, mouse, or the like. The label information input by the input unit 60 is supplied to the label assignment unit 14 of the annotation apparatus 1. The label assignment unit 14 assigns a label to each cluster according to the label information supplied from the input unit 60.

The point cloud data storage unit 70 stores the point cloud data that is the three-dimensional position information about the measurement target. The point cloud data is acquired in advance using a three-dimensional distance sensor such as LIDAR. When the annotation processing is performed by the annotation apparatus 1, the point cloud data storage unit 70 supplies the point cloud data to be subjected to the annotation processing to the annotation apparatus 1.

The annotation data storage unit 80 stores the data that has been subjected to the annotation processing. Specifically, the annotation data storage unit 80 stores data related to each cluster and data related to labels assigned to each cluster in association with each other. The annotation data stored in the annotation data storage unit 80 can be used as teacher data for machine learning.

Although FIG. 8 shows the case where the point cloud data storage unit 70 and the annotation data storage unit 80 are configured separately, the point cloud data storage unit 70 and the annotation data storage unit 80 may be configured using the same storage unit. In addition, the storage unit for storing the point cloud data and the annotation data may be built into the annotation apparatus 1. For example, the annotation apparatus 1 may be configured by a personal computer.

In this example embodiment, the annotation apparatus 1 may be configured as an application server. In this case, the point cloud data storage unit 70, the annotation data storage unit 80, the display unit 50, and the input unit 60 are provided on a client side. When the annotation processing is performed, the user on the client side transmits the point cloud data stored in the point cloud data storage unit 70 to the annotation apparatus 1. The annotation apparatus 1 performs processing to group the point cloud data transmitted from the user to generate a plurality of clusters and processing to determine the presentation order of the plurality of clusters based on the similarity between the generated plurality of clusters.

After that, the annotation apparatus 1 sequentially displays each cluster on the user's display unit 50 based on the determined presentation order. The user inputs the label information about each cluster displayed on the display unit 50 using the input unit 60. The label information input using the input unit 60 is transmitted to the annotation apparatus 1. The annotation apparatus 1 assigns label information to each cluster. The annotation apparatus 1 performs the annotation processing by repeating processing of presenting each of the plurality of clusters to the user in turn and processing of assigning a label input by the user to the cluster. In this way, the annotation data is generated. The generated annotation data is transmitted from the annotation apparatus 1 to the user's annotation data storage unit 80.

When the annotation apparatus 1 is configured as an application server, a plurality of users can access the annotation apparatus 1 and perform the annotation processing.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The present disclosure is not limited to the above example embodiment and can be changed as appropriate without departing from the scope.

### REFERENCE SIGNS LIST

1 Annotation Apparatus
11 Cluster Generation Unit
12 Presentation Order Determination Unit
13 Cluster Presentation Unit
14 Label Assignment Unit
21, 22, 23 Point
31, 32, 33 Cluster
50 Display Unit
51, 52, 53, 54 Cluster
60 Input Unit
70 Point Cloud Data Storage Unit
80 Annotation Data Storage Unit
101 CPU
102 Memory

What is claimed is:

1. An annotation apparatus comprising:
a cluster generation unit configured to generate a plurality of clusters by grouping point cloud data corresponding to three-dimensional position information about a measurement target;
a presentation order determination unit configured to determine a presentation order of the plurality of clusters based on a degree of similarity between the generated plurality of clusters;
a cluster presentation unit configured to present the plurality of clusters in order based on the determined presentation order; and
a label assignment unit configured to assign a predetermined label to each of the clusters presented in the order.

2. The annotation apparatus according to claim 1, wherein the presentation order determination unit determines the presentation order of the plurality of clusters based on at least one of a degree of spatial similarity and a degree of visual similarity between the plurality of clusters.

3. The annotation apparatus according to claim 2, wherein
the presentation order determination unit determines
that the closer a spatial positional relationship between the plurality of clusters is, the higher the degree of the spatial similarity, and
that the closer appearances of the plurality of clusters are, the higher the visual similarity.

4. The annotation apparatus according to claim 2, wherein
the presentation order determination unit
creates a graph by coupling each of the plurality of clusters with edges based on the spatial similarity between the plurality of clusters,
sets a weight for each of the edges coupling the clusters based on the visual similarity between the plurality of clusters, and
determines the presentation order of each of the clusters based on the set weight of each of the edges.

5. The annotation apparatus according to claim 4, wherein
the presentation order determination unit
creates a minimum spanning tree of the plurality of clusters based on the set weight of each of the edges, and
performs a depth-first search on the minimum spanning tree to determine the presentation order of each of the clusters.

6. The annotation apparatus according to claim 5, wherein the presentation order determination unit performs the depth-first search on the minimum spanning tree, prioritizing reduction in a spatial gap between the clusters.

7. The annotation apparatus according to claim 1, wherein
the cluster presentation unit sequentially presents each of the plurality of clusters in order based on the presentation order determined by the presentation order determination unit, and
the label assignment unit assigns a label to each of the sequentially presented clusters according to a predetermined input.

8. An annotation method comprising:
generating a plurality of clusters by grouping point cloud data corresponding to three-dimensional position information about a measurement target;
determining a presentation order of the plurality of clusters based on similarity between the generated plurality of clusters;
presenting the plurality of clusters in order based on the determined presentation order; and
assigning a predetermined label to each of the clusters presented in the order.

9. A non-transitory computer readable medium storing a program for causing a computer to execute annotation processing comprising:
processing of generating a plurality of clusters by grouping point cloud data corresponding to three-dimensional position information about a measurement target;
processing of determining a presentation order of the plurality of clusters based on similarity between the generated plurality of clusters;
processing of presenting the plurality of clusters in order based on the determined presentation order; and
processing of assigning a predetermined label to each of the clusters presented in the order.
